(19) United States
(12) Patent Application Publication
(10) Pub. No.: US 2026/0287774 A1
(43) Pub. Date: Sep. 24, 2026

(54) PORE VOLUME UNCERTAINTY ANALYSIS FOR CARBON CAPTURE AND SEQUESTRATION

(71) Applicant: SAUDI ARABIAN OIL COMPANY, Dhahran (SA)

(72) Inventors: Elhindy Elsharif, Dhahran (SA); Zainab Alabdulmohsen, Dhahran (SA)

(73) Assignee: SAUDI ARABIAN OIL COMPANY, Dhahran (SA)

(21) Appl. No.: 19/088,107

(22) Filed: Mar. 24, 2025

(51) Int. Cl. G01V 1/30; E21B 41/00; E21B 49/00; G01V 1/28; G01V 1/34; G01V 20/00

(52) U.S. Cl. CPC G01V 1/306; E21B 41/0064; E21B 49/00; G01V 1/282; G01V 1/345; G01V 20/00; E21B 2200/20; E21B 2200/22

(57) ABSTRACT

Methods and systems are disclosed. The method may include obtaining a seismic dataset from a subsurface of interest and a first porosity log and a first permeability log for each well drilled within the subsurface of interest. The method further includes, for each of two or more variants, determining a horizon, that defines a reservoir within the subsurface of interest, within the seismic dataset, determining a structural model for the reservoir based on the horizon, and determining a simulated porosity model and a simulated permeability model. The simulated porosity model is based on the first porosity log for each well and porosity variogram models. The simulated permeability model is based on the first permeability log for each well and permeability variogram models. The method still further includes determining an estimated pore volume based on the simulated porosity model, simulated permeability model, a metric, and seed numbers.

### BACKGROUND

Carbon capture and sequestration methods may combat global warming by capturing and storing carbon dioxide rather than releasing the carbon dioxide into the atmosphere. Carbon dioxide may be captured from industrial processes, such as those performed in power plants and refineries, or directly from the atmosphere of the Earth. The captured carbon dioxide can be stored in a multitude of ways, which includes permanent or semi-permanent storage in underground geological formations.

To effectively store carbon dioxide in a geological formation, rock properties of the geological formation must be adequately determined prior to storage. However, data pertaining to the geological formation may be limited in quality and/or quantity. Accordingly, the rock properties determined using the data may be uncertain. Uncertain rock properties could lead to misuse of and/or damage to the geological formation.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method. The method includes obtaining, using a seismic acquisition system, a seismic dataset from a subsurface of interest and obtaining, using a well logging system, a first porosity log and a first permeability log for each of a first set of wells drilled within the subsurface of interest. The method further includes, for each variant, determining, using a seismic interpretation workstation, a horizon within the seismic dataset and determining a structural model based on the horizon, where the horizon defines a reservoir within the subsurface of interest. The method still further includes determining an initial porosity model within the structural model based on the first porosity log for each of the first set of wells, determining porosity variogram models based on at least one of the first porosity log for each of the first set of wells and a second porosity log for each of a second set of wells, and determining a simulated porosity model using each of the porosity variogram models for each of the porosity variogram models. The method also includes determining an initial permeability model within the structural model based on the first permeability log for each of the first set of wells, determining permeability variogram models based on at least one of the first permeability log for each of the first set of wells and a second permeability log for each of the second set of wells, and determining a simulated permeability model using each of the permeability variogram models for each of the permeability variogram models. The method additionally includes determining an initial pore volume within the structural model based on the simulated porosity model and the simulated permeability model for each variogram pair, determining a first intermediate pore volume from the initial pore volumes based on a metric, generating each second intermediate pore volume based on the first intermediate pore volume and each seed number, determining an estimated pore volume from the second intermediate pore volumes, configuring an injection system to perform a method of injecting the reservoir with an injection fluid based on the estimated pore volume, and performing, using the injection system, the method of injecting the reservoir.

In general, in one aspect, embodiments relate to a system. The system includes a seismic interpretation workstation, computer system, and injection system. The seismic interpretation workstation is configured to receive, from a seismic acquisition system, a seismic dataset associated with a subsurface of interest and determine a horizon within the seismic dataset for each variant. The computer system is configured to receive, from the seismic interpretation workstation, the horizon and receive, from a well logging system, a first porosity log and a first permeability log for each of a first set of wells drilled within the subsurface of interest. The computer system is further configured to, for each variant, determine a structural model based on the horizon, determine an initial porosity model within the structural model based on the first porosity log for each of the first set of wells, determine porosity variogram models based on at least one of the first porosity log for each of the first set of wells and a second porosity log for each of a second set of wells, and determine a simulated porosity model using each of the porosity variogram models for each of the porosity variogram models. The computer system is still further configured to determine an initial permeability model within the structural model based on the first permeability log for each of the first set of wells, determine a plurality of permeability variogram models based on at least one of the first permeability log for each of the first set of wells and a second permeability log for each of the second set of wells, and determine a simulated permeability model using each of the permeability variogram models for each of the permeability variogram models. The computer system is also configured to determine an initial pore volume within the structural model based on the simulated porosity model and the simulated permeability model for each variogram pair. The computer system is additionally configured to determine a first intermediate pore volume from the initial pore volumes based on a metric, generate each second intermediate pore volume based on the first intermediate pore volume and each seed number, determine an estimated pore volume from the second intermediate pore volumes, and configure an injection system to perform a method of injecting the reservoir with an injection fluid based on the estimated pore volume. The injection system is configured to perform the method of injecting the reservoir.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 shows a subsurface in accordance with one or more embodiments.

FIG. 2 shows a seismic acquisition system in accordance with one or more embodiments.

FIG. 3 shows a seismic image in accordance with one or more embodiments.

FIG. 4 shows a well logging system in accordance with one or more embodiments.

FIG. 5 displays a variogram in accordance with one or more embodiments.

FIG. 6 shows a workflow in accordance with one or more embodiments.

FIG. 7 depicts a method in accordance with one or more embodiments.

FIG. 8 shows an injection system in accordance with one or more embodiments.

FIG. 9 shows a computer system in accordance with one or more embodiments.

FIG. 10 depicts systems in accordance with one or more embodiments.

### DETAILED DESCRIPTION

In the following detailed description of embodiments of the disclosure, numerous specific details are set forth to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

In the following description, any component described regarding a figure, in various embodiments disclosed herein, may be equivalent to one or more like-named components described regarding any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as optional embodiments which may be implemented in addition to, in conjunction with, or in place of the embodiments described regarding a corresponding like-named component in any other figure.

It is to be understood that the singular forms “a,” “an,” and “the” include plural referents unless the context clearly dictates otherwise. Thus, for example, reference to “a seismic dataset” includes reference to one or more of such seismic datasets.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims may not be introduced, it would be apparent to one of ordinary skill that the subject matter of the dependent claims of one or more embodiments may be combined with other dependent claims.

Methods and systems are disclosed to determine a pore volume of a reservoir located within a subsurface of interest. To do so, the disclosed methods rely on a seismic dataset obtained from the subsurface of interest and well logs obtained from wells drilled within the subsurface of interest.

Though the seismic dataset and well logs are used, this data may be limited in quantity and/or quality. For example, high-resolution well logs may only exist for a handful of wells drilled within the subsurface of interest. Accordingly, the high-resolution well logs may only characterize a limited portion of the subsurface of interest. Further, a low-resolution seismic dataset, though expansive over the subsurface of interest, may be of poor quality. Accordingly, using this limited data may cause large uncertainties in the pore volume as well as large uncertainties in a horizon, structural model, porosity model, and permeability model used to determine the pore volume of the reservoir.

Advantageously, the disclosed methods and systems may reduce the uncertainty in the horizon, structural model, porosity model, permeability model, and/or pore volume of the reservoir compared to other methods and systems that do the same. To reduce the uncertainty, the disclosed methods may strategically rely on multiple types of porosity and permeability variogram models, collocated cokriging, seismic inversion, and variants based on various distributions. Accordingly, the disclosed methods and systems may increase confidence in the horizon, structural model, porosity model, permeability model, and/or pore volume of the reservoir.

Adequately identifying the horizon and quantifying the structural model, porosity model, permeability model, and pore volume of the reservoir within the subsurface of interest may inform carbon capture and sequestration methods and systems used to inject carbon dioxide (a type of injection fluid) into the reservoir. As global warming worsens, the need for effective data-driven carbon capture and sequestration methods and systems increases. However, current carbon capture and sequestration methods and systems, such as injection systems and methods the injection systems are configured to perform, may be designed ad hoc, based on experience and/or common sense, and/or based on an inadequately-small amount of data or number of pilot tests. Such methods of design may lead to overdesign or under design of carbon capture and sequestration methods and systems. Overdesign may result in excessive cost, unnecessary complexity, and/or wasted effort. Under design may result in an inability of the carbon capture and sequestration methods and systems to meet capture and sequestration requirements and/or excessive cost to fund design changes. The disclosed methods and systems may provide a solution as they can be used to inform the design of carbon capture and sequestration methods and systems. As such, the data-driven carbon capture and sequestration methods and systems may be used to effectively store carbon dioxide in the reservoir, rather than releasing the carbon dioxide into the atmosphere, to thereby lessen global warming.

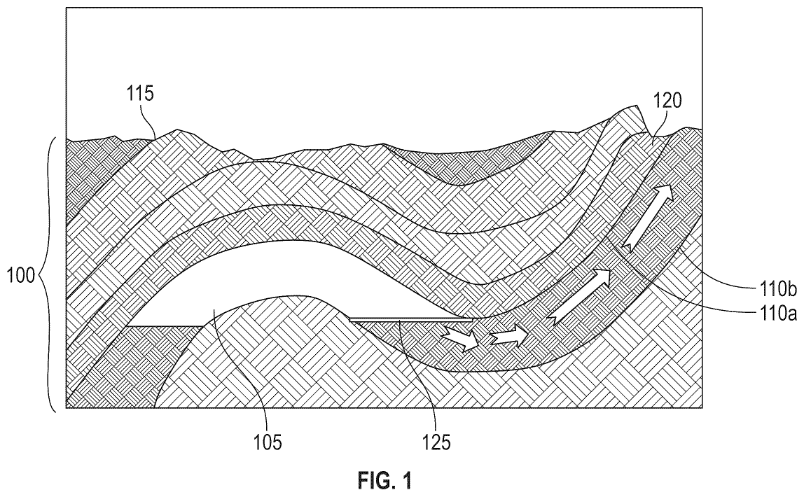

Turning to FIG. 1, FIG. 1 illustrates a subsurface 100 in accordance with one or more embodiments. The subsurface 100 includes a reservoir 105 (i.e., container), which may include layers of geological formations. The reservoir 105 and each geological formation may be separated by a geological discontinuity 110a, b. The geological discontinuity 110a, b above and/or below the reservoir 105 may define a boundary of the reservoir 105. A surface 115 is shown above the subsurface 100. That is, the subsurface 100 may be a location within the crust of the Earth and the surface 115 may be a location on or above the crust of the Earth.

Geological formations targeted for carbon capture and sequestration are capped by a seal formation 120, a type of geological formation. The seal formation 120 creates a hill-like shape to form a “cap” for the reservoir 105. Further, a seal formation 120 is typically a tight formation (i.e., low permeability) that prevents fluids within the reservoir 105 from migrating out of the reservoir 105. A seal formation 120 is shown directly above the reservoir 105 in FIG. 1.

A person skilled in the art will appreciate that the thickness and geometry of the subsurface 100 depicted in FIG. 1 are for example purposes only and not meant to be limiting. That is, the geological formations within the subsurface 100 may have any type of thickness or geometry.

FIG. 1 further depicts the spill point 125 of the reservoir 105. The spill point 125 is the lowest level within the reservoir 105 where further storage or retention of fluid will not occur as additional fluid may escape from the reservoir 105 and percolate or migrate to unintended locations, such as the surface 115. Thus, how much injection fluid the reservoir 105 can hold is a function of the spill point 125. As illustrated in FIG. 1, a relative minimum of an upper geological discontinuity 110a may define the spill point 125.

In some embodiments, the reservoir 105 may be a single reservoir within a single field as shown in FIG. 1. In other embodiments, the reservoir 105 may be a stacked reservoir within a single field that includes distinct geological formations or “layers” located one on top of another within the reservoir 105. All the layers may be located beneath the seal formation 120, may be in fluid communication with one another, and may be targeted for injection fluid storage. In still other embodiments, the reservoir 105 may be a regional reservoir that includes a one or more reservoirs within two or more fields. Further, in some embodiments, the reservoir 105 may be a hydrocarbon reservoir that stores, or previously stored, hydrocarbons. In these embodiments, injection fluid may be pumped into the reservoir 105 for dual purposes: to aid in production of the hydrocarbons and to store the injection fluid.

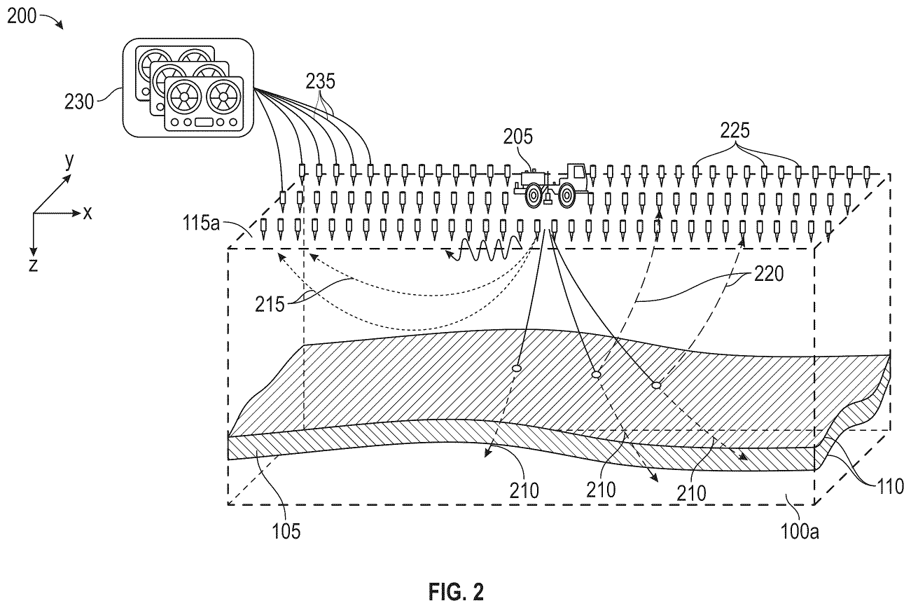

FIG. 2 shows a seismic acquisition system 200 in accordance with one or more embodiments. The seismic acquisition system 200 is deployed over a surface of the Earth 115a above a subsurface of interest 100a. The subsurface of interest 100a may include the subsurface 100 and reservoir 105 as outlined in FIG. 1. The seismic acquisition system 200 may be configured to obtain a seismic dataset from a subsurface of interest 100a. To do so, the seismic acquisition system 200 may be configured to conduct or perform a seismic survey over the subsurface of interest 100a. It may require hundreds to thousands of crew members to deploy the seismic acquisition system 200 and facilitate performing the seismic survey. Further, the seismic survey may take on the order of weeks or months. Preparing for and conducting the seismic survey is a multidisciplinary and dynamic process.

The seismic acquisition system 200 may include a seismic source 205 positioned on or near the surface of the Earth 115a. The seismic source 205 is configured to generate or radiate seismic waves when activated. FIG. 2 illustrates paths the seismic waves may take using rays 210. Hereinafter, the reference character associated with a given ray is also used to denote the type of seismic wave the ray indicates. Accordingly, the reference character 210 denotes the rays 210 and the radiated seismic waves 210 the rays indicate. Returning to the seismic source 205, on land, the seismic source 205 is typically a vibroseis truck (as shown) or, less commonly, explosive charges, such as dynamite, buried to a shallow depth. The vibroseis truck, which may weigh on the order of tens of tons, may include a steel-plated vibration platform fixed to a chassis. When activated, the steel-plated vibration platform may be lowered to the surface of the Earth 115a and vibrate to generate the seismic waves. In water, particularly in the ocean, the seismic source 205 may be an airgun (not shown) that releases a pulse of high-pressure gas when activated.

The radiated seismic waves 210 may be bent (e.g., reflected, refracted) at geological discontinuities 110 within the subsurface of interest 100a. Some may return to the surface of the Earth 115a as refracted seismic waves 215 or reflected seismic waves 220.

The refracted seismic waves 215 and reflected seismic waves 220 may be detected by seismic receivers 225 positioned at or near the surface 115. On land, each seismic receiver 225 may be a geophone (that records the velocity of ground motion caused by the seismic waves) or an accelerometer (that records the acceleration of ground motion caused by the seismic waves). In water, each seismic receiver 225 may be a hydrophone that records pressure disturbances within the water caused by the seismic waves. Irrespective of its mechanical design, each seismic receiver 225 may be configured to detect or sense seismic waves and convert the detected seismic waves into a seismic dataset in the form of electrical signals, which are recorded by a seismic recorder 230 as a time-series. In some embodiments, the electrical signals may be transferred from each seismic receiver 225 to the seismic recorder 230 via fiber optic cable 235. Each time-series is typically referred to as a “seismic trace” and represents the amplitude of the detected seismic waves at each time sample. Accordingly, the seismic dataset may include a collection of seismic traces. Usually, the first time sample is aligned to the time the seismic source 205 is activated.

In some cases, a single seismic source 205 may be configured to perform, in part, the seismic survey. In these cases, the seismic source 205 may be moved sequentially from one seismic source location to another during the seismic survey. In other cases, multiple seismic sources 205 may be configured to perform, in part, the seismic survey. In these cases, each seismic source 205 may be positioned at a unique seismic source location and activated sequentially. Colloquially, a single activation of the seismic source 205 may be referred to as a “shot.” Thousands of shots may be performed per day over the course of a seismic survey. Shots may be performed sequentially or simultaneously.

Similarly, some or all the seismic receivers 225 may be moved between activations of the seismic source 205. For example, the seismic receivers 225 may be moved such that the seismic source 205 remains at the center of the area covered by the seismic receivers 225 as the seismic source 205 is moved from one seismic source location to the next. In other cases, such as during a marine seismic survey, the seismic source 205 may be towed a short distance behind a seismic vessel and strings of seismic receivers 225 attached to multiple cables (“streamers”) towed behind the seismic source 205. In some embodiments, a seismic survey may rely on tens of thousands of strings of seismic receivers 225, where multiple seismic receivers 225 are fixed to each string. Accordingly, in some embodiments, a seismic survey may rely on tens to hundreds of thousands of seismic receivers 225 to conduct a seismic survey.

Denoting the position of the seismic source 205 as xₛ=(x′ₛ, y′ₛ) and the position of each seismic receiver 225 as xᵣ=(x′ᵣ, y′ᵣ), respectively, the seismic trace detected by each seismic receiver 225 may be denoted D(x′ₛ, y′ₛ, x′ᵣ, y′ᵣ, t). Here, t is recording time or the time elapsed after the activation of the seismic source 205. The collection of all seismic traces acquired during the seismic survey is denoted the seismic dataset. Accordingly, the seismic dataset may be initially collected in a time domain.

Prior to using the seismic dataset, the seismic dataset may need to be processed. Processing the seismic dataset includes a sequence of steps designed to correct for near-surface effects, attenuate noise, compensate for irregularities in the seismic survey geometry, and calculate a seismic velocity model (to convert to the domain associated with the subsurface of interest 100a). Hereinafter, the sequence of steps may be denoted “seismic processing” or simply “processing.” Following seismic processing, the seismic dataset may be displayed in the form of a seismic image.

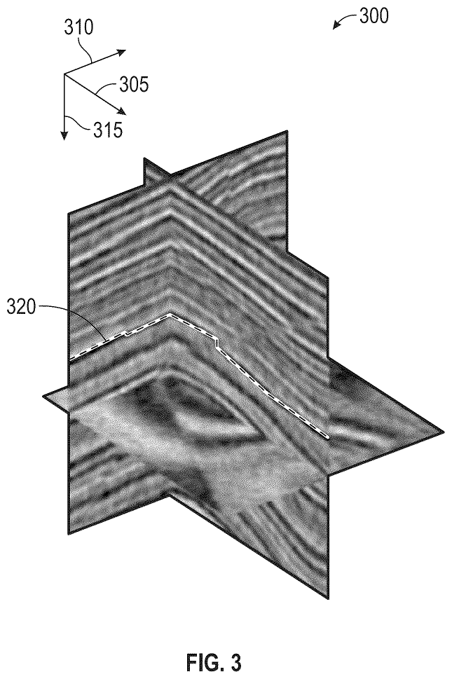

FIG. 3 shows a seismic image 300 in accordance with one or more embodiments. In FIG. 3, the seismic image 300 is three-dimensional and corresponds to the dimensions of the subsurface of interest 100a. That is, the crossline axis 305 may denote the x-axis shown in FIG. 2, the inline axis 310 may denote the y-axis, and the depth axis 315 may denote the z-axis. The seismic image 300 may be displayed in grayscale where white designates a large positive amplitude and black designates a large negative amplitude.

A large positive or negative amplitude in the seismic image 300 may be a manifestation of a geological discontinuity 110. Hereinafter, a manifestation of a geological discontinuity 110 within a seismic image 300 is denoted a horizon 320. In some cases, a horizon 320 may define an upper or lower boundary of a reservoir 105 within the subsurface of interest 100a.

However, the seismic processing and resolution of the seismic dataset and/or seismic image 300 greatly affects the ability of a seismic interpreter (hereinafter simply “interpreter”) to properly identify a horizon 320 within the seismic image 300. Accordingly, there may be uncertainty in the identified horizon 320. To reduce this uncertainty, multiple horizons 320 may be identified that are intended to be the same horizon 320. In some embodiments, multiple horizons 320 may be identified by multiple interpreters over multiple days using seismic images 300 of various resolutions that have been processed differently. This process may be referred to as an uncertainty analysis. The variability in the horizons 320 may be quantified using a distribution.

Variants may be selected from the multiple horizons 320 or the distribution of horizons. In some embodiments, the variants may be percentiles. For example, the variants may be the 10^{th}, 50^{th}, and 90^{th} percentile of the distribution. In other embodiments, the variants may be different percentiles. In still other embodiments, a different statistical measure of the multiple horizons 320 or distribution may define the variants, such as standard deviation, variance, etc. For generality, the variants may be denoted “variant 1” through “variant N,” where N is a natural number.

For each variant, the horizon 320 may be used to determine a reservoir volume for the reservoir 105. For example, a reservoir volume may be determined for each of the 10^{th}, 50^{th}, and 90^{th} percentile horizon. Accordingly, the 10^{th}, 50^{th}, and 90^{th} percentile reservoir volumes are different. In some embodiments, the reservoir volume may be the volume of a portion of the reservoir 105 able to store or retain fluid, such as injection fluid. For example, the horizon 320 may define a geological discontinuity 110a that resides above and adjacent to a reservoir 105. Accordingly, the horizon 320 may define the upper boundary of the reservoir volume and a relative minimum of the horizon 320 may define the lower boundary of the reservoir volume known as the spill point 125 as previously described relative to FIG. 1. In other embodiments, one or more additional horizons 320 and/or one or more bounds of the seismic survey may further define the reservoir volume for each variant. Hereinafter, the reservoir volume is referred to as a “structural model.”

Continuing with the structural model, each structural model may be separated into grid cells (hereinafter “cells”) for later use. The size of the cells may be based on some predefined resolution and/or the resolution of data, such as the seismic dataset and/or well logs. For example, in some embodiments, such as for a single reservoir, each structural model may be separated into cells where the length and width of each cell is 100 meters and the height of each cell is based on the resolution of a well log. In other embodiments, such as for a stacked reservoir, each structural model may be separated into cells where the length and width of each cell is 150 meters and the height of each cell is based on the resolution of a well log. In still other embodiments, such as for a regional reservoir, each structural model may be separated into cells where the length and width of each cell is 250 meters and the height of each cell is based on the resolution of a well log. However, a person of ordinary skill in the art will appreciate that the structural model may be separated into any size of cells that adequately captures the lateral and/or vertical heterogeneity of the reservoir 105 or portion thereof.

Following interpretation of the seismic image 300, wells may be drilled within the subsurface of interest 100a to further explore the subsurface of interest 100a. In some embodiments, some wells may penetrate the reservoir 105 located within the subsurface of interest 100a. In other embodiments, some wells may penetrate a reservoir 105 located within neighboring subsurfaces (i.e., neighboring fields), analog subsurfaces, or subsurfaces with a similar reservoir as the reservoir 105 within the subsurface of interest 100a. In still other embodiments, some wells may not penetrate a reservoir 105. A well logging system 400 may be configured to obtain one or more well logs from each well 405.

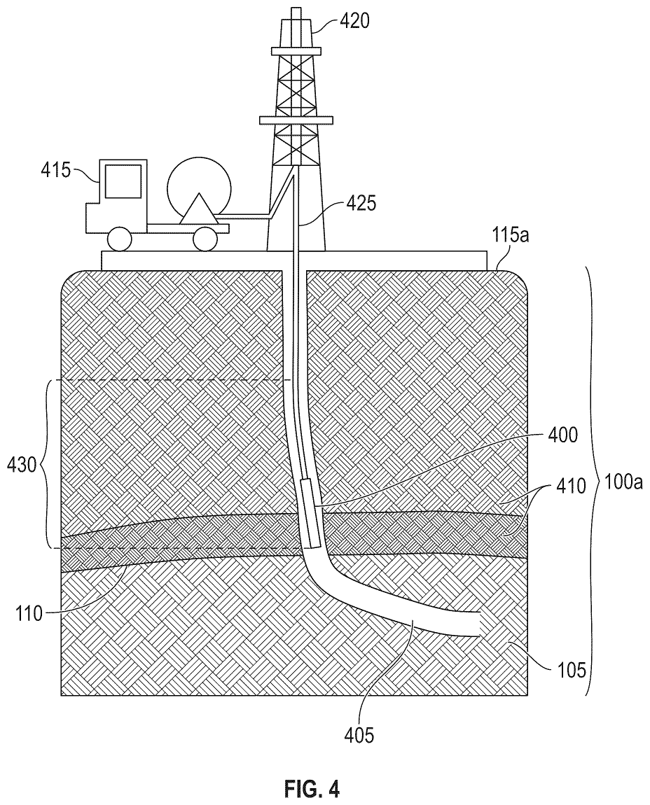

FIG. 4 illustrates a well logging system 400 in accordance with one or more embodiments. Prior to deploying the well logging system 400 downhole, a well 405 may be partially or completely drilled within the subsurface of interest 100a, for example, using a rock coring system or drilling system. The well 405 may traverse layers of rock 410 (i.e., geological formations) separated by geological discontinuities 110 and/or other structural features before hopefully penetrating a reservoir 105. In some embodiments, the well logging system 400 may be lowered into the well 405 following the removal of the rock coring system or drilling system. The well logging system 400 may be supported by a truck 415 and derrick 420 above ground. For example, the truck 415 may carry a conveyance mechanism 425 used to lower the well logging system 400 into the well 405. The conveyance mechanism 425 may be used to lower the well logging system 400 into the well 405. The conveyance mechanism 425 may be a wireline, coiled tubing, or drillpipe that may include means to provide power to the well logging system 400 and a telemetry channel from the well logging system 400 to the surface of the Earth 115a. In some embodiments, the well logging system 400 may be translated along the well 405 to acquire a well log over an interval 430 of the well 405.

The well logging system 400 may be configured to collect or obtain a porosity log and permeability log for each of a first set of wells 405 drilled within the subsurface of interest 100a neighboring subsurfaces, analog subsurfaces, or subsurfaces with a similar reservoir as the reservoir 105 within the subsurface of interest 100a. To do so, in some embodiments, the porosity log and/or permeability log may be derived from another log the well logging system 400 is configured to collect or obtain. For example, the permeability log may be derived from a nuclear magnetic resonance (NMR) log. Accordingly, the well logging system 400 may be or include without limitation, an acoustic logging tool (which may be a sonic logging tool), density logging tool, neutron porosity logging tool, NMR logging tool, and any combination thereof.

In some embodiments, each well log may resolve information every 5-10 feet or 10-20 feet, either of which may be considered a low resolution. In other embodiments, each well log may resolve information every 1-2 feet or 3-5 feet, either of which may be considered a high resolution. However, other distances may be used without departing from the scope of the disclosure and should not be limiting. As noted previously, the resolution of a well log may define the vertical resolution of the cells within the structural model.

In some embodiments, porosity logs may be used to determine an initial porosity model and permeability logs used to determine an initial permeability model. The initial porosity model may include an initial porosity value at each cell within the structural model. The initial permeability model may include an initial permeability value at each cell within the structural model. Some cells may be associated with a fixed porosity value and fixed permeability value. These fixed cells may be associated with the same location as a well 405 where a porosity log and/or permeability log were/was obtained. Accordingly, the fixed porosity value and fixed permeability value may come directly from a porosity log and permeability log. The remaining simulated cells of the structural model may be associated with an interpolated porosity value and interpolated permeability value each of which are interpolated from the porosity logs and permeability logs, respectively. The simulated cells may also be referred to as “modeled cells.” Accordingly, because the porosity logs and permeability logs may only sample a small portion of the subsurface of interest 100a, the initial porosity model and initial permeability model may have large uncertainties at the simulated cells positioned far away from fixed cells due to the lack of porosity logs and/or permeability logs.

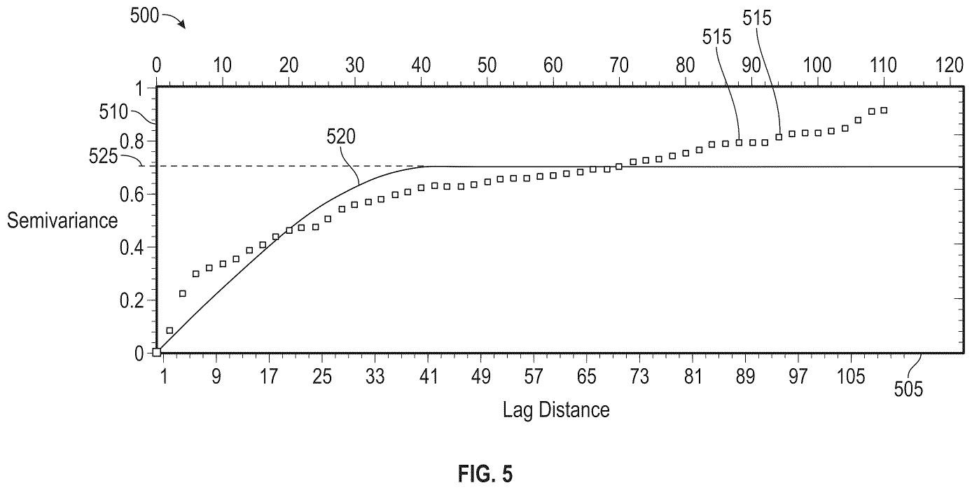

To reduce uncertainty, variogram models may be used. In the context of this disclosure, a variogram may quantify the variance or parameter derived from variance of porosity and permeability as a function of spatial distance (hereinafter “lag distance”). Accordingly, variograms quantify spatial uncertainty of a parameter. For example, FIG. 5 displays a porosity variogram 500 in accordance with one or more embodiments. In these embodiments, the abscissa 505 denotes lag distance and the ordinate 510 denotes semivariance (i.e., half the variance). Each point 515 of the porosity variogram 500 denotes the semivariance as a function of lag distance or the distance between two cells. FIG. 5 specifically shows an increase in semivariance as the lag distance increases. In other words, the porosity value at each of two cells among the initial porosity model becomes more different from one another as the spatial distance between the two cells increases. In some embodiments, a porosity variogram model 520 (i.e., an empirical porosity variogram) may be fit to the points 515 or portion thereof of the porosity variogram 500. In some embodiments, the porosity variogram model 520 may only be fit to the points 515 that exhibit a correlation. For example, points 515 may no longer be correlated past the sill 525 in FIG. 5.

Hereinafter, the general term “variogram” is used to generally discuss variograms. However, a person of ordinary skill in the art will appreciate that a variogram may quantify the spatial variability of any variable, such as porosity and permeability, using any parameter, such as semivariance. In some embodiments, the variable may be a geological or petrophysical variable.

Further, in some embodiments, each variogram may be a horizontal variogram or vertical variogram. A horizontal variogram may quantify spatial uncertainty of a variable in a horizontal plane of the subsurface of interest 100a, for example. A vertical variogram may quantity spatial uncertainty of a variable in a vertical plane of the subsurface of interest 100a, for example.

Further still, variograms may be determined for various subsurfaces. In some embodiments, an optimum variogram may include points 515 determined from well logs obtained from wells 405 drilled within the subsurface of interest 100a. As such, in some embodiments, the optimum variogram may quantify the lateral heterogeneity of the variable up to a certain lag distance where points beyond this lag distance exhibit little-to-no correlation. In some embodiments, a long variogram may include points 515 determined from well logs obtained from wells 405 drilled within a neighboring subsurface, analog subsurface, or subsurface with a similar reservoir as the reservoir 105 within the subsurface of interest 100a. As such, in some embodiments, the long variogram may quantify the lateral heterogeneity of the variable within and beyond the certain lag distance. Accordingly, in some embodiments, the long variogram may include a dense number of points 515 that adequately quantifies the subsurface due to the expansive number of wells 405 drilled within that subsurface. However, the optimum variogram may include a sparse number of points 515 that may not adequately quantify the subsurface of interest 100a due to the limited number of wells 405 drilled within the subsurface of interest 100a. Further, in some embodiments, a nested variogram may include points 515 that alternate between the points 515 of the long variogram and the points 515 of the optimum variogram based on a predetermined rule. Accordingly, the nested variogram may quantify zonal anisotropy (e.g., lateral spatial variability per zone) of the variable at multiple scales. As such, the nested variogram may be referred to as a directional nested variogram. In some embodiments, the optimum variogram may be used to determine a value of the variable at each simulated cell that is located within the certain lag distance that the optimum variogram quantifies the variable for. The long variogram may be used to determine a value of the variable at each simulated cell beyond the certain lag distance that the optimum variogram quantifies the variable for. In some embodiments, kriging, a spatial interpolation technique, may be performed to determine a value of the variable for remaining simulated cells.

Accordingly, a long variogram model, such as porosity variogram model 520, may be fit to a long variogram. Further, an optimum variogram model may be fit to an optimum variogram. Still further, a nested variogram model may be fit to a nested variogram.

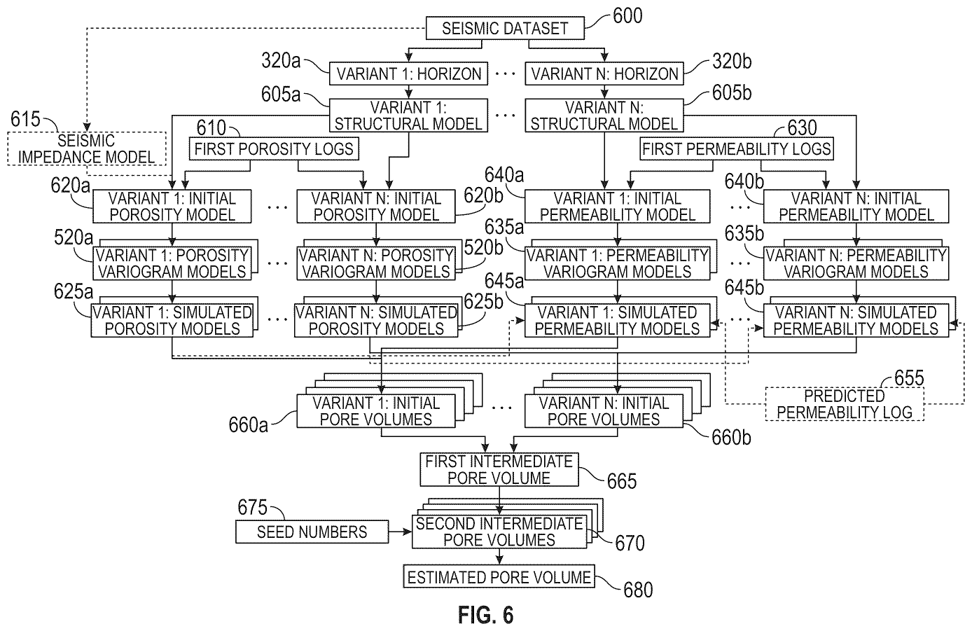

FIG. 6 illustrates a workflow in accordance with one or more embodiments. The workflow may be followed to reduce the uncertainty in a horizon 320, structural model, porosity model, permeability model, and pore volume associated with a reservoir 105 within a subsurface of interest 100a.

A seismic dataset 600 may be obtained and processed to determine one or more seismic images 300. The one or more seismic images 300 may be interpreted, by one or more interpreters, to identify multiple horizons 320 that are meant to be the same horizon 320. Each of the multiple horizons 320 may be a manifestation of a geological discontinuity 110 that defines a boundary of the reservoir 105 within the subsurface of interest 100a as previously described relative to FIG. 1. Accordingly, the multiple horizons 320 are meant to capture the variability of the true horizon 320 that defines the boundary of the reservoir 105. In some embodiments, the variability in the multiple horizons 320 may be quantified using a distribution and variants of the distribution selected. The variants may be values of any statistical measure of the multiple horizons 320 or distribution of multiple horizons 320. For example, the statistical measure may be percentile, standard deviation, or variance. If the statistical measure is percentile, the values may be the 10^{th}, 50^{th}, and 90^{th} percentile. Accordingly, in some embodiments, the variants are meant to broadly and discretely capture the variability of the true horizon 320. For illustration purposes only, FIG. 6 depicts a horizon 320a, b for each of two variants generically denoted “variant 1” and “variant N.” However, the ellipsis (i.e., . . . ) between the horizons 320a, b indicate that any number of two or more variants may be used without departing from the scope of the disclosure.

For each variant, the horizon 320a, b may be used to determine the structural model 605a, b. To do so, a simple volume calculation may be performed to determine the structural model 605a, b for the reservoir 105, where the horizon 320a, b defines the boundaries of the reservoir volume. FIG. 6 depicts a structural model 605a, b for each of variant 1 and variant N.

For each variant, a porosity model may be initialized and the uncertainty in the porosity model mitigated. The process of mitigating the uncertainty in the porosity model is illustrated on the left-hand side of FIG. 6. In some embodiments, the porosity model associated with each variant may be initialized by interpolating between the first porosity logs 610 obtained at a first set of wells 405 drilled within the subsurface of interest 100a that are within the structural model 605a, b. Any method of interpolation known to a person of ordinary skill in the art may be used, such as a Gaussian random function simulation (GRFS). In other embodiments, seismic inversion may be performed using the seismic dataset 600 to determine a seismic impedance model 615 or other secondary variable. In these embodiments, the porosity model associated with each variant may be initialized by collocated cokriging between the first porosity logs 610 obtained at wells 405 drilled within the subsurface of interest 100a that are within the structural model 605a, b and the seismic impedance model 615. These embodiments are illustrated in FIG. 6 using dotted lines to indicate this as an optional step.

For each variant, multiple porosity variogram models 520a, b may be determined for each initial porosity model 620a, b. Accordingly, for example, FIG. 6 illustrates two porosity variogram models 520a for variant 1 and two porosity variogram models 520b for variant N. In some embodiments, the porosity variogram models 520a, b for each variant may include a long porosity variogram model, optimum porosity variogram model, and nested porosity variogram model, so three porosity variogram models 520a, b for each variant. However, other porosity variogram models 520a, b may be used without departing from the scope of the disclosure. Each porosity variogram model 520a, b for each variant may be used to determine or construct a simulated porosity model 625a, b. Accordingly, FIG. 6 illustrates two simulated porosity models 625a for variant 1 and two simulated porosity models 625b for variant N. To determine each simulated porosity model 625a, b, the porosity value at each simulated cell within each initial porosity model 620a, b may be updated using the semivariance and lag distance within the corresponding porosity variogram model 520a, b.

Turning to the permeability model, for each variant, a permeability model may be initialized and the uncertainty in the permeability model mitigated. The process of mitigating the uncertainty in the permeability model is illustrated on the right-hand side of FIG. 6. In some embodiments, the permeability model associated with each variant may be initialized by interpolating between the first permeability logs 630 obtained at wells 405 drilled within the subsurface of interest 100a that are within the structural model 605a, b. Any method of interpolation known to a person of ordinary skill in the art may be used. In other embodiments, the permeability model associated with each variant may be initialized by collocated cokriging between the first permeability logs 630 obtained at wells 405 drilled within the subsurface of interest 100a that are within the structural model 605a, b and the simulated porosity model 625a, b associated with the corresponding variant. These embodiments are illustrated in FIG. 6 using dotted lines to indicate this as an optional step.

For each variant, multiple permeability variogram models 635a, b may be determined for each initial permeability model 640a, b. Accordingly, for example, FIG. 6 illustrates two permeability variogram models 635a for variant 1 and two permeability variogram models 635b for variant N. In some embodiments, the permeability variogram models 635a, b for each variant may include a long permeability variogram model, optimum permeability variogram model, and nested permeability variogram model, so three permeability variogram models 635a, b for each variant. However, other permeability variogram models 635a, b may be used without departing from the scope of the disclosure. Each permeability variogram model 635a, b for each variant may be used to determine or construct a simulated permeability model 645a, b. Accordingly, FIG. 6 illustrates two simulated permeability models 645a for variant 1 and two simulated permeability models 645b for variant N. To determine each simulated permeability model 645a, b, the permeability value at each simulated cell within each initial permeability model 640a, b may be updated using the semivariance and lag distance within the corresponding permeability variogram model 635a, b.

In some embodiments, artificial intelligence or machine learning may be used to predict or produce a predicted permeability log 655 for each of a first set of wells 405 and, in some embodiments, a test well. The predicted permeability log 655 for each of the first set of wells 405 and, in some embodiments, the test well may be used to further inform the simulated permeability models 645a, b. To do so, in some embodiments, a machine learning model, such as Facimage, may be trained and the trained machine learning model used to predict the predicted permeability log 655 from input logs associated with each of the first set of wells 405 and the test well. The predicted permeability log 655 may be referred to as a matrix permeability log that quantifies static permeability. Accordingly, a multiplier may be applied to the predicted permeability log 655 for each of the first set of wells 405 to produce a multiplied predicted permeability log that quantifies dynamic permeability. In some embodiments, each simulated permeability model 645a, b may be further updated by collocated cokriging between the predicted permeability log 655 or multiplied predicted permeability log, the input logs associated with each of the first set of wells 405 drilled within the subsurface of interest 100a that are within the structural model 605a, b, and/or the simulated porosity model 625a, b. These embodiments are illustrated in FIG. 6 using dotted lines to indicate this as an optional step.

In some embodiments, the multiplier may be determined by performing an injection test. Prior to performing the injection test, a simulated permeability model 645a, b may be input into an injection test simulator. The injection test simulator may produce predicted injection input parameters. An injection test may then be performed within the test well drilled within the subsurface of interest 100a. The injection test may be based on the predicted injection input parameters. Further, the injection test may be performed by an injection system. Observed injection output parameters (i.e., dynamic data) may be obtained from the injection test. The observed injection output parameters may include observed values of mobility, injection fluid flow rate, and injection fluid pressure. The observed injection output parameters may be compared to expected or wanted injection output parameters. Further, the observed injection output parameters may be used to determine a measured permeability log for the test well, which may quantify dynamic permeability. The predicted permeability log 655 for the test well may be calibrated to the measured permeability log to determine the multiplier.

For each variogram pair, the simulated porosity model 625a, b and simulated permeability model 645a, b are used to determine an initial pore volume 660a, b within the structural model 605a, b. Each variogram pair includes a porosity variogram model 520a, b and permeability variogram model 635a, b. In some embodiments, the porosity variogram model 520a, b and permeability variogram model 635a, b may be the same type of model, such as a long variogram model. In other embodiments, the porosity variogram model 520a, b and permeability variogram model 635a, b may be different types of models. Further, in some embodiments, the two variogram models within each variogram pair may be associated with the same variant, such as variant 1, or different variants. For illustrative purposes only, FIG. 6 illustrates the variogram pairs as being different types of models and the same variant. Accordingly, FIG. 6 shows four initial pore volumes 660a for variant 1 and four initial pore volumes 660b for variant N. In other embodiments, more or less initial pore volumes 660a, b may be determined.

A first intermediate pore volume 665 may be determined from the initial pore volumes 660a, b. In some embodiments, the first intermediate pore volume 665 may be determined based on a metric of the initial pore volumes 660a, b. In some embodiments, the metric is a mean of the initial pore volumes 660a, b. In some embodiments, the first intermediate pore volume 665 may be selected as the mean of the initial pore volumes 660a, b. In other embodiments, the first intermediate pore volume 665 may be selected as the initial pore volume 660a, b closest to the mean.

Second intermediate pore volumes 670 (i.e., realizations) may be determined or generated using the first intermediate pore volume 665 and seed numbers 675. Each seed number 675 may be a random number that dictates the starting point for generating each second intermediate pore volume 670. In some embodiments, a GRFS may be used to generate each second intermediate pore volume 670. Accordingly, in some embodiments, each seed number 675 and the GRFS are used to determine each second intermediate pore volume 670.

The estimated pore volume 680 may then be determined using the second intermediate pore volumes 670. To do so, in some embodiments, a distribution may be fit to the second intermediate pore volumes 670 and the mean of the distribution determined or selected as the estimated pore volume 680.

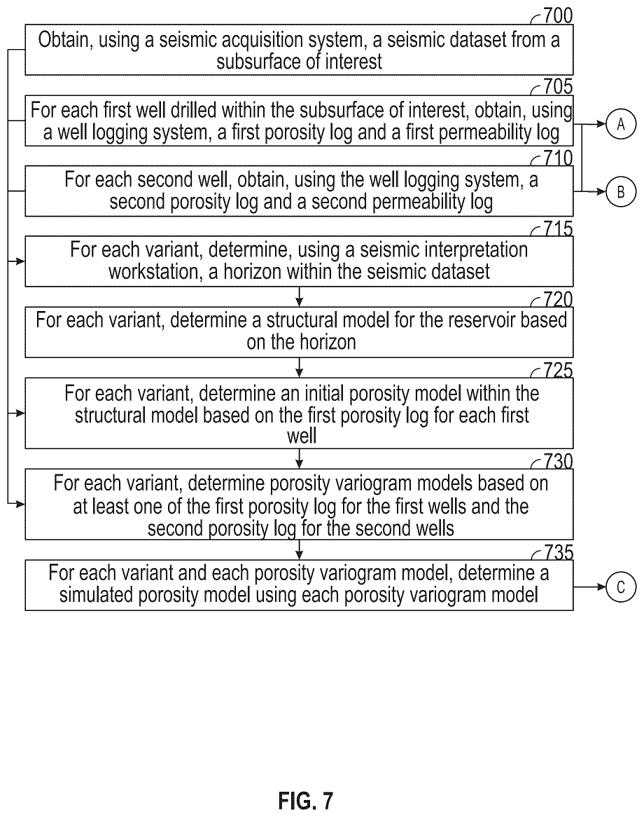

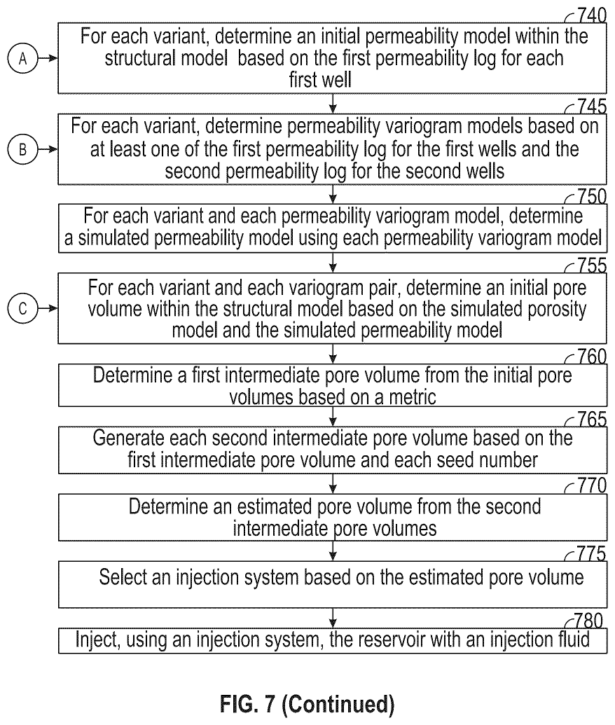

FIG. 7 describes a method in accordance with one or more embodiments. Although the steps in FIG. 7 are shown in sequential order, some steps may be conducted in parallel, in a different order, omitted, or repeated without departing from the scope of the disclosure. Further, each step as described below may be optionally performed. For example, step 710 may be optionally performed if used in steps 730 and/or 745.

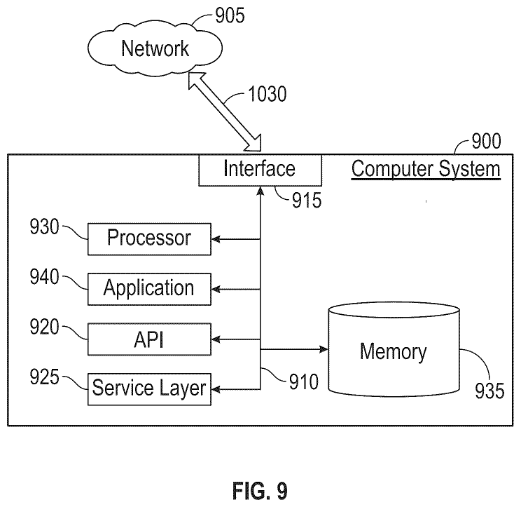

In step 700, a seismic dataset 600 is obtained from a subsurface of interest 100a. The seismic dataset 600 may be obtained using the seismic acquisition system 200 as described relative to FIG. 2. In some embodiments, the seismic dataset 600 may be transferred to and received by a seismic processing system. The seismic processing system may process the seismic dataset 600. In these embodiments, the processed seismic dataset 600 may be transferred to and received by a seismic interpretation workstation. The processed seismic dataset 600 may be displayed in the form of a seismic image 300 using the seismic interpretation workstation. The seismic processing system and seismic interpretation workstation are discussed in detail relative to FIG. 9.

In step 705, a first porosity log 610 and first permeability log 630 are obtained for each of a first set of wells 405 drilled within the subsurface of interest 100a. Each first porosity log 610 and each first permeability log 630 may be obtained using a well logging system 400 as described relative to FIG. 4. In some embodiments, each first porosity log 610 may be derived or estimated from an immediately-collected well log, such as from a neutron porosity log. In some embodiments, each first permeability log 630 may be derived or estimated from one or more immediately-collected well logs. In some embodiments, the well logging system 400 used to obtain each first porosity log 610 may be different than the well logging system 400 used to obtain each first permeability log 630. Further, in some embodiments, the wells 405 where each first porosity log 610 is obtained from may be different wells 405, in whole or in part, where each first permeability log 630 is obtained from.

In step 710, a second porosity log and second permeability log are obtained for each of a second set of wells 405. Each of the second set of wells 405 may be drilled within neighboring subsurfaces, analog subsurfaces, and/or subsurfaces with a similar reservoir as the reservoir 105 within the subsurface of interest 100a. Each second porosity log and each second permeability log may be obtained using a well logging system 400 as described relative to FIG. 4. In some embodiments, each second porosity log may be derived or estimated from an immediately-collected well log, such as from a neutron porosity log. In some embodiments, each second permeability log may be derived or estimated from one or more immediately-collected well logs. Further, in some embodiments, the wells 405 where each second porosity log is obtained may be different wells 405, in whole or in part, where each second permeability log is obtained from.

Steps 715, 720, 725, 730, 735, 740, 745, 750, and 755 are performed for each of multiple variants. Step 715 may be performed using the seismic interpretation workstation. Steps 720, 725, 730, 735, 740, 745, 750, 755, 760, 765, 770, and 775 may be performed using a computer system. The computer system is described relative to FIG. 9.

In some embodiments, the variants may be variants of or based on multiple horizons 320 determined from the seismic dataset 600. For example, in step 715, a horizon 320a, b is determined within the seismic dataset 600. To do so, the seismic dataset 600 is processed to form the seismic image 300 and the seismic image 300 interpreted by an interpreter to identify a horizon 320a, b within the seismic image 300. The horizon 320a b defines a boundary of the reservoir 105 within the subsurface of interest 100a. In some embodiments, the horizon 320a, b may define the portion of the reservoir 105 able to store or retain fluid as previously described relative to FIG. 1.

However, there may be uncertainty associated with identifying the horizon 320a, b as the sequence of steps used to determine the seismic image 300, the resolution of the seismic image 300, and/or the interpreter that interprets the seismic image 300 may affect the position of the horizon 320a, b. The variants are used to quantify the uncertainty of the position of the horizon 320a, b. To do so, in some embodiments, different sequences of steps may be used to determine different seismic images 300, different resolutions of the seismic images 300 may be generated, and/or multiple interpreters may interpret the seismic images 300 to generate multiple horizons 320a, b each of which are intended to be the true horizon 320a, b that defines the reservoir 105 or portion thereof. Horizons 320a, b at different variants may then be selected. For example, in some embodiments, the variants may be the 10^{th}, 50^{th}, and 90^{th} percentile of the multiple horizons 320a, b. The horizon 320a, b determined in step 715 may then be the horizon 320a, b of the 10^{th}, 50^{th} (i.e., median), and 90^{th} percentile among the multiple horizons 320a, b.

In step 720, for each variant, a structural model 605a, b is determined for the reservoir 105 or portion thereof based on the horizon 320a, b. To do so, in some embodiments, the horizon 320a, b may define a boundary of the structural model 605a, b. Accordingly, a simple volume calculation may be performed to determine the structural model 605a, b for the reservoir 105 or portion thereof.

In step 725, for each variant, an initial porosity model 620a, b is determined within the structural model 605a, b based on the first porosity log 610 obtained from each of the first set of wells 405. In some embodiments, the structural model 605a, b for each variant may be separated into cells where a porosity value is initialized at each cell. In these embodiments, the fixed cells associated with the same location of each of the first set of wells 405 may be associated to a porosity value from the first porosity log 610 while the porosity value for the remaining simulated cells is interpolated. Optionally, seismic inversion may determine a seismic impedance model 615 from the seismic dataset 600. In some embodiments, collocated cokriging may be performed to determine the porosity value for the remaining simulated cells using the seismic impedance model 615 and the first porosity log 610 obtained for each of the first set of wells 405. In other embodiments, collocated cokriging may be performed to determine the porosity value for the remaining simulated cells using the first porosity log 610 obtained for each of the first set of wells 405 and the simulated permeability model 645a, b (as is described in step 750 below).

In step 730, for each variant, porosity variogram models 520a, b are determined using at least one of the first porosity log 610 for each of the first set of wells 405 and the second porosity log for each of the second set of wells 405.

In step 735, for each variant and each porosity variogram model 520a, b, a simulated porosity model 625a, b is determined. To do so, each porosity variogram model 520a, b may be used to estimate the porosity value at each simulated cell within each initial porosity model 620a, b using the semivariance, or other parameter, within the corresponding porosity variogram model 520a, b. By doing so, the variability of porosity values in the simulated porosity model 625a, b more closely resembles the corresponding porosity variogram model 520a, b compared to porosity values within the initial porosity model 620a, b.

In step 740, for each variant, an initial permeability model 640a, b is determined within the structural model 605a, b based on the first permeability log 630 obtained from each of the second set of wells 405. In some embodiments, the structural model 605a, b for each variant may be separated into cells where a permeability value is initialized at each cell. In these embodiments, the fixed cells associated with the same location of each of the second set of wells 405 may be associated to a permeability value from the permeability log 630 while the permeability value for the remaining simulated cells is interpolated. In some embodiments, collocated cokriging may be performed to determine the permeability value for the remaining simulated cells using the first permeability log 630 obtained for each of the second set of wells 405 and the simulated porosity model 625a, b. In other embodiments, collocated cokriging may be performed to determine the permeability value for the remaining simulated cells using the first permeability log 630 obtained for each of the second set of wells 405 and the seismic impedance model 615.

In step 745, for each variant, permeability variogram models 635a, b are determined using at least one of the first permeability log 630 for each of the first set of wells 405 and the second permeability log for each of the second set of wells 405.

In step 750, for each variant and each permeability variogram model 635a, b, a simulated permeability model 645a, b is determined. To do so, each permeability variogram model 635a, b may be used to estimate the permeability value at each simulated cell within each initial permeability model 640a using the semivariance, or other parameter, within the corresponding permeability variogram model 635a, b. By doing so, the variability of permeability values in the simulated permeability model 645a, b more closely resembles the corresponding permeability variogram model 635a, b compared to permeability values within the initial permeability model 640a, b.

In step 755, for each variant and each variogram pair, an initial pore volume 660a, b is determined using the simulated porosity model 625a, b and simulated permeability model 645a, b. Each variogram pair includes a porosity variogram model 520a, b and permeability variogram model 635a, b. In some embodiments, the porosity variogram model 520a, b and permeability variogram model 635a, b may be the same type of model, such as a long variogram model. In other embodiments, the porosity variogram model 520a, b and permeability variogram model 635a, b may be different types of models. Further, in some embodiments, the two variogram models within each variogram pair may be associated with the same variant, such as variant 1, or different variants. Accordingly, multiple initial pore volumes 660a, b are generated for each variant.

In step 760, a first intermediate pore volume 665 is determined from the initial pore volumes 660a, b based on a metric. In some embodiments, the metric is a mean of the initial pore volumes 660a, b. In some embodiments, the first intermediate pore volume 665 may be selected as the mean of the initial pore volumes 660a, b. In other embodiments, the first intermediate pore volume 665 may be selected as the initial pore volume 660a, b closest to the mean. However, in other embodiments, the metric may be the median, mode, or other statistical measure of the initial pore volumes 660a, b.

In step 765, second intermediate pore volumes 670 are determined. To do so, each second intermediate pore volume 670 may be generated using the first intermediate pore volume 665, a random seed number 675, and, in some embodiments, a GRFS.

In step 770, an estimated pore volume 680 is determined using the second intermediate pore volumes 670. To do so, in some embodiments, a distribution may be fit to the second intermediate pore volumes 670 and the mean of the distribution determined or selected as the estimated pore volume 680.

In step 775, an injection system is configured or designed to perform a method of injecting the reservoir 105 with an injection fluid. The injection system, method of injection, and/or injection fluid may be designed or selected based on the estimated pore volume 680, one or more simulated porosity models 625a, b, and/or one or more simulated permeability models 645a, b. The method may include injecting, using the injection system, the reservoir 105 with the injection fluid at a prescribed injection rate, injection pressure, injection temperature, etc., each of which may vary over time, for an intended purpose. Intended purposes are discussed below.

In step 780, the method is performed using the injection system. The injection system and method of injection are discussed below.

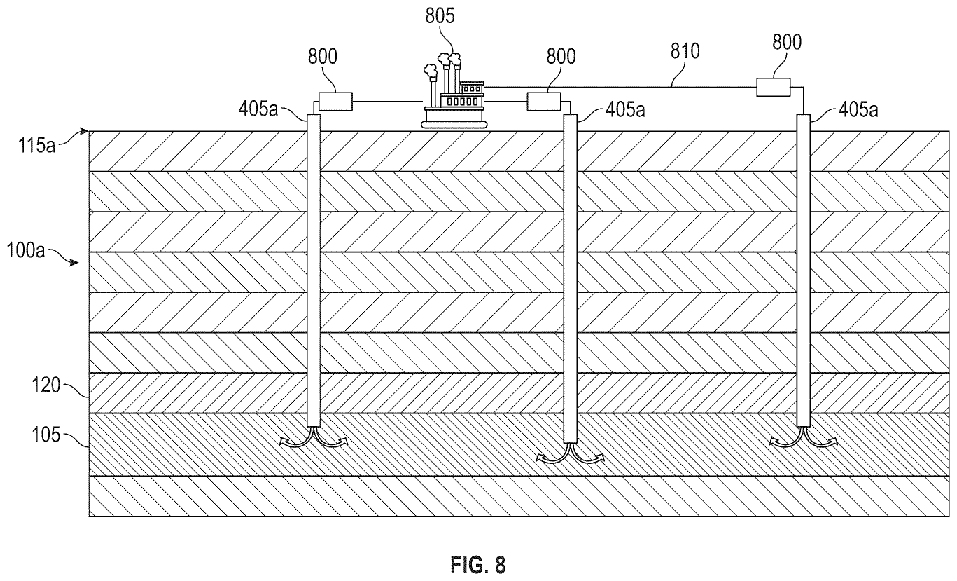

Turning to systems, FIG. 8 illustrates injection systems 800 in accordance with one or more embodiments. Each injection system 800 is configured or designed to perform a method of injecting the reservoir 105 with an injection fluid. In some embodiments, the injection fluid may be injected into an injection well 405a and the reservoir 105 within the subsurface of interest 100a that the injection well 405a penetrates. To do so, in some embodiments, each injection system 800 may be in fluid communication with a power plant 805 via a conduit 810. In other embodiments, any system (including the atmosphere) that produces or has injection fluids may replace the power plant 805. Injection fluid, such as carbon dioxide, produced by the power plant 805 may flow along the conduit 810 to each injection well 405a where the injection fluid is pumped into the reservoir 105 via the injection well 405a.

The injection system 800 may be configured or designed for one or more intended purposes. An intended purpose may include, without limitation, injection fluid storage, reservoir pressure maintenance, and production enhancement. If the injection system 800 is configured for injection fluid storage, the injection fluid may be injected into the injection well 405a and reservoir 105 and be stored, permanently or for a time, in the reservoir 105. The injected and stored fluid may be any fluid. In some embodiments, such as in carbon capture and sequestration methods, carbon dioxide may be the injected and stored fluid. In other embodiments, fluid waste may be the injected and stored fluid. In these embodiments, injection may serve as a method of disposal. If the injection system 800 is configured for reservoir pressure maintenance, the injection fluid may be selected or designed such that when the injection fluid is stored in the reservoir 105, adequate pressure of the reservoir 105 is maintained to avoid, for example, collapse of the reservoir 105. If the injection system 800 is configured for production enhancement, the injection fluid may be injected into the injection well 405a and reservoir 105 to displace production, such as oil and gas, towards a production well 405 (not shown in FIG. 8) to produce the production (and, in some embodiments, some of the injection fluid) to the surface of the Earth 115a. Accordingly, the injection fluid may be designed to or selected that have specific physical properties needed to adequately displace the production towards the production well 405.

For the injection system 800 to perform any of the intended purposes, the pore volume, porosity, and/or permeability of the reservoir 105 need to be quantified to understand how the injection fluid will pervade the reservoir 105. The disclosed method quantifies the pore volume, porosity, and permeability of the reservoir 105 as the estimated pore volume 680, one or more simulated porosity models 625a, b, and/or one or more simulated permeability models 645a, b. The estimated pore volume 680 may quantify the volume across the reservoir 105 that is able to store fluid. The one or more simulated porosity models 625a, b may quantify what percentage across the reservoir 105 is able to store fluid. The one or more simulated permeability models 645a, b may quantify the ease with which fluid, such as injection fluid, may flow across the reservoir 105. Once quantified, the injection fluid may be determined, the method of injection determined, and/or the injection system 800 configured based on the pore volume, porosity, permeability, and intended purpose. In some embodiments, the injection fluid may be designed or selected such that, when it is in the reservoir 105, the injection fluid adequately performs the intended purpose (e.g., remains stored in the reservoir 105, adequately maintains the pressure of the reservoir 105, or displaces production towards a production well 405). In some embodiments, the method of injection may be designed such that the injection fluid adequately performs the intended purpose. The method of injection (i.e., an injection plan) may include a prescribed injection rate, injection pressure, injection temperature, etc., when to vary each over time, and for how long to inject the injection fluid into the injection well 405a. In some embodiments, the injection system 800 may be configured to adequately pump the designed or selected injection fluid into the injection well 405a and reservoir 105 as prescribed by the method for the intended purpose. Parts of the injection system 800 may include an injection wellhead, injection pump, conduit 810, flowline, pressure regulator, filter, separator, fluid tank, etc. Each part must be designed or selected such that the selected or designed injection fluid can be pumped into the injection well 405a and reservoir 105 using the injection system 800 as prescribed by the method. As such, each part of the injection system 800 must be able to withstand the prescribed injection rate, injection pressure, injection temperature, etc. of the injection fluid.

FIG. 9 shows a computer system 900 in accordance with one or more embodiments. In some embodiments, the computer system 900 may be specifically configured for seismic processing and denoted a “seismic processing system.” Additionally, or alternatively, the computer system 900 may be specifically configured for seismic interpretation and denoted a “seismic interpretation workstation.” Further, in other embodiments, the seismic acquisition system 200, well logging system 400, seismic processing system, seismic interpretation workstation, and/or injection system 800 may include a computer system 900. While the term computer system 900 may be used to describe each of the parts of a computer system 900 in the following paragraphs, the terms “seismic processing system” or “seismic interpretation workstation” may replace the term “computer system” 900 without departing from the scope of the disclosure.

The computer system 900 is intended to depict any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer system 900 may include an input device, such as a keypad, keyboard, touch screen, or other device that can accept user information, and an output device that displays information, including digital data, visual or audio information (or a combination of both), or a graphical user interface (GUI). Specifically, a seismic interpretation workstation may include a robust graphics card for the detailed rendering of the seismic image 300 such that the seismic image 300 may be displayed and manipulated by the interpreter in a virtual reality system using 3D goggles, a mouse, or a wand to determine the horizon 320.

The computer system 900 can serve in a role as a client, network component, server, database, or any other component (or a combination of roles) of a computer system 900 as required for seismic processing and seismic interpretation. The illustrated computer system 900 is communicably coupled with a network 905. For example, a seismic processing system and seismic interpretation workstation may be communicably coupled via the network 905. In some implementations, one or more components of each computer system 900 may be configured to operate within environments, including cloud-computing-based, local, global, or other environment (or a combination of environments).

At a high level, the computer system 900 is an electronic computing device operable to receive, transmit, process, store, and/or manage data and information associated with the disclosed methods. According to some implementations, the computer system 900 may also include or be communicably coupled with an application server, e-mail server, web server, caching server, streaming data server, business intelligence (BI) server, or other server (or a combination of servers).

Because seismic processing and seismic interpretation may not be sequential, the computer system 900 can receive requests over the network 905 from other computer systems 900 or another client application and respond to the received requests by processing the requests appropriately. In addition, requests may also be sent to the computer system 900 from internal users (for example, from a command console or by other appropriate access method), external or third-parties, other automated applications, as well as any other appropriate entities, individuals, systems, or computer systems 900.

Each of the components of the computer system 900 can communicate using a system bus 910. In some implementations, any or all of the components of each computer system 900, both hardware or software (or a combination of hardware and software), may interface with each other or the interface 915 (or a combination of both) over the system bus 910 using an application programming interface (API) 920 or a service layer 925 (or a combination of the API 920 and service layer 925. The API 920 may include specifications for routines, data structures, and object classes. The API 920 may be either computer-language independent or dependent and refer to a complete interface, a single function, or even a set of APIs. The service layer 925 provides software services to each computer system 900 or other components (whether or not illustrated) that are communicably coupled to each computer system 900. The functionality of each computer system 900 may be accessible for all service consumers using this service layer 925. Software services, such as those provided by the service layer 925, provide reusable, defined business functionalities through a defined interface. For example, the interface may be software written in JAVA, C++, or other suitable language providing data in extensible markup language (XML) format or another suitable format. While illustrated as an integrated component of each computer system 900, alternative implementations may illustrate the API 920 or the service layer 925 as stand-alone components in relation to other components of each computer system 900 or other components (whether or not illustrated) that are communicably coupled to each computer system 900. Moreover, any or all parts of the API 920 or the service layer 925 may be implemented as child or sub-modules of another software module, enterprise application, or hardware module without departing from the scope of this disclosure.

The computer system 900 includes the interface 915. Although illustrated as a single interface 915 in FIG. 9, two or more interfaces 915 may be used according to particular needs, desires, or particular implementations of each computer system 900. The interface 915 is used by each computer system 900 for communicating with other systems in a distributed environment that are connected to the network 905. Generally, the interface 915 includes logic encoded in software or hardware (or a combination of software and hardware) and operable to communicate with the network 905. More specifically, the interface 915 may include software supporting one or more communication protocols associated with communications such that the network 905 or interface's hardware is operable to communicate physical signals within and outside of the illustrated computer system 900.

The computer system 900 includes at least one computer processor 930. Generally, a computer processor 930 executes any instructions, algorithms, methods, functions, processes, flows, and procedures as described above. A computer processor 930 may be a central processing unit (CPU) and/or a graphics processing unit (GPU). The seismic dataset 600 may be tens to hundreds of terabytes or even petabytes in size where multiple terabytes may be acquired per day. To efficiently perform the method described in FIG. 7, a seismic processing system may consist of an array of CPUs with one or more subarrays of GPUs attached to each CPU. Further, tape readers or high-capacity hard-drives may be connected to the CPUs using wide-band system buses 910.

The computer system 900 also includes a memory 935, i.e., a non-transitory computer readable medium, that stores data and software, i.e., computer-executable instructions, for the computer system 900 or other components (or a combination of both) that can be connected to the network 905. In some embodiments, the memory 935 may store the seismic dataset 600, seismic image 300, first and second porosity logs 610, and first and second permeability logs 630. Although illustrated as a single memory 935 in FIG. 9, two or more memories 935 may be used according to particular needs, desires, or particular implementations of the computer system 900 and the described functionality. While memory 935 is illustrated as an integral component of each computer system 900, in alternative implementations, memory 935 can be external to each computer system 900.

The application 940 is an algorithmic software engine providing functionality according to particular needs, desires, or particular implementations of the computer system 900, particularly with respect to functionality described in this disclosure. For example, application 940 can serve as one or more components, modules, applications, etc. Further, although illustrated as a single application 940, the application 940 may be implemented as multiple applications 940 on each computer system 900. In addition, although illustrated as integral to each computer system 900, in alternative implementations, the application 940 can be external to each computer system 900.

There may be any number of computer systems 900, such as computer clusters, associated with, or external to, a seismic processing system and seismic interpretation workstation, where each computer system 900 communicates over the network 905. Further, the term “client,” “user,” and other appropriate terminology may be used interchangeably as appropriate without departing from the scope of this disclosure. Moreover, this disclosure contemplates that many users may use the computer system 900, or that one user may use multiple computer systems 900.

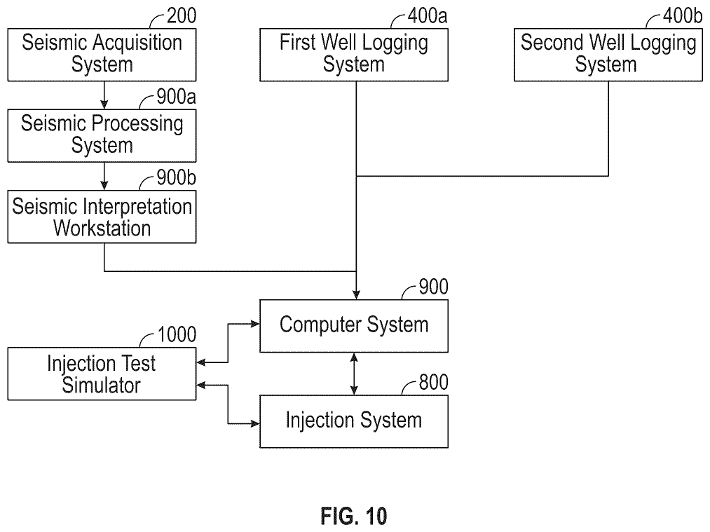

FIG. 10 shows a flowchart of systems in accordance with one or more embodiments. The system may include at least two of a seismic acquisition system 200, seismic processing system 900a, seismic interpretation workstation 900b, well logging system 400, computer system 1400, injection test simulator 1000, and injection system 800. Each part of the system may be communicably coupled with any other part of the system via the network 905. The seismic acquisition system 200, seismic processing system 900a, seismic interpretation workstation 900b, well logging system 400, and/or injection system 800 may include a computer system 900. In some embodiments, the seismic processing system 900a and/or seismic interpretation workstation 900b may be a computer system 900.

In some embodiments, the seismic acquisition system 200 may be configured to obtain the seismic dataset 600 from the subsurface of interest 100a as described in step 700 and relative to FIG. 2. The seismic dataset 600 may be transferred from the seismic acquisition system 200 to the seismic processing system 900a. The seismic processing system 900a may receive and store the seismic dataset 600. The seismic processing system 900a is configured to process the seismic dataset 600.

The processed seismic dataset 600 may be transferred to and stored by the seismic interpretation workstation 900b. The seismic interpretation workstation 900b may display the processed seismic dataset 600 as the seismic image 300 as described relative to FIG. 3. An interpreter interrupts the seismic image 300 to determine a horizon 320a, b as described in step 715. The horizon 320a, b may be transferred to and stored by the computer system 900.

Turning to the well logging system 400, the well logging system 400 may be configured to obtain the first porosity log 610 and first permeability log 630 from each of the first set of wells 405 drilled within the subsurface of interest 100a as described in step 705. In some embodiments, the well logging system 400 may be configured to obtain the second porosity log and second permeability log from each of the second set of wells 405 drilled within the neighboring subsurfaces, analog subsurfaces, and/or subsurfaces with a similar reservoir as the reservoir 105 within the subsurface of interest 100a as described in step 710. The first and second porosity logs 610 and first and second permeability logs 630 may be transferred to and stored by the computer system 900.

The computer system 900 may be configured to perform steps 720, 725, 730, 735, 740, 745, 750, 755, 760, 765, 770, and 775 to ultimately determine an estimated pore volume 680 and select the injection system 800 based on the estimated pore volume 680.

In some embodiments, to further update the simulated permeability model 645a, b, the injection test simulator 1000 may be configured to produce predicted injection input parameters based on the simulated permeability model 645a, b input into the injection test simulator 1000. The predicted injection input parameters may inform an injection test performed in a test well 405a drilled within the subsurface of interest 100a. The injection system 800 may be configured to perform the injection test. Observed injection output parameters may be obtained from the test well 405a during and/or following the injection test. The observed injection output parameters may be used to update the simulated permeability model 645a, b such that the observed injection output parameters obtained from the test well 405a during and/or following another injection test more closely matches expected or wanted injection output parameters.

Following the selection of the injection system 800 in step 775, the injection system 800 may be configured to inject an injection fluid into the reservoir 105 for permanent or semi-permanent storage as described in step 780. The injection fluid may include carbon dioxide, natural gas, hydrogen, or any fluid designated for permanent or semi-permanent storage. Note the injection system 800 configured to perform the injection test may be a different injection system 800 configured to inject the reservoir 105 with injection fluid.

In summary, the disclosed methods and systems may reduce the uncertainty in the horizon 320a, b, structural model 605a, b, simulated porosity model 625a, b, simulated permeability model 645a, b, and/or estimated pore volume 680 associated with a reservoir 105 or portion thereof located within a subsurface of interest 100a. Accordingly, confidence may be gained that the reservoir 105 is being adequately used for carbon capture and sequestration.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method comprising:
obtaining, using a seismic acquisition system, a seismic dataset from a subsurface of interest;
for each of a first plurality of wells drilled within the subsurface of interest, obtaining, using a well logging system, a first porosity log and a first permeability log;
for each of a plurality of variants:
determining, using a seismic interpretation workstation, a horizon within the seismic dataset,
wherein the horizon defines a reservoir within the subsurface of interest,
determining a structural model for the reservoir based on the horizon,
determining an initial porosity model within the structural model based on the first porosity log for the first plurality of wells,
determining a plurality of porosity variogram models based on at least one of the first porosity log for the first plurality of wells and a second porosity log for a second plurality of wells,
for each of the plurality of porosity variogram models, determining a simulated porosity model using each of the plurality of porosity variogram models,
determining an initial permeability model within the structural model based on the first permeability log for the first plurality of wells,
determining a plurality of permeability variogram models based on at least one of the first permeability log for the first plurality of wells and a second permeability log for the second plurality of wells,
for each of the plurality of permeability variogram models, determining a simulated permeability model using each of the plurality of permeability variogram models, and
for each variogram pair among a plurality of variogram pairs, determining an initial pore volume within the structural model based on the simulated porosity model and the simulated permeability model,
wherein each variogram pair comprises one of the plurality of porosity variogram models and one of the plurality of permeability variogram models, and
wherein a plurality of initial pore volumes comprises the initial pore volume for each variogram pair for each of the plurality of variants;
determining a first intermediate pore volume from the plurality of initial pore volumes based on a metric;
generating each of a plurality of second intermediate pore volumes based on the first intermediate pore volume and each of a plurality of seed numbers;
determining an estimated pore volume from the plurality of second intermediate pore volumes; and
configuring an injection system to perform a method of injecting the reservoir with an injection fluid based on the estimated pore volume; and
performing, using the injection system, the method of injecting the reservoir.

2. The method of claim 1, further comprising for each of the second plurality of wells, obtaining, using the well logging system, the second porosity log and the second permeability log.

3. The method of claim 1, wherein the plurality of variants comprises a plurality of percentiles.

4. The method of claim 1, wherein the structural model defines a portion of the reservoir able to store fluid.

5. The method of claim 1, wherein determining the initial porosity model comprises interpolating a porosity value at each of a plurality of cells using the first porosity log for the first plurality of wells,
wherein the plurality of cells represents the reservoir.

6. The method of claim 1, wherein determining the initial porosity model comprises:
determining, using seismic inversion, a seismic impedance model from the seismic dataset; and
collocated cokriging a porosity value at each of a plurality of cells using the first porosity log for the first plurality of wells and the seismic impedance model,
wherein the plurality of cells represents the reservoir.

7. The method of claim 1, wherein the plurality of porosity variogram models comprises a nested porosity variogram model.

8. The method of claim 1, wherein determining the initial permeability model comprises collocated cokriging a permeability value at each of a plurality of cells using the first permeability log for the first plurality of wells and the simulated porosity model,
wherein the plurality of cells represents the reservoir.

9. The method of claim 1, wherein determining the simulated permeability model comprises:
for each well among the first plurality of wells and a test well:
inputting a plurality of logs associated with each well into a trained machine learning (ML) model,
wherein the machine learning model is trained to produce a predicted permeability log from the plurality of logs,
producing the predicted permeability log from the trained ML model, and
determining a multiplied predicted permeability log by applying a multiplier to the predicted permeability log; and
collocated cokriging a permeability value at each of a plurality of cells using the multiplied predicted permeability log for the first plurality of wells, the plurality of logs for the first plurality of wells, and the simulated porosity model,
wherein the plurality of cells represents the reservoir.

10. The method of claim 9, wherein determining the multiplied predicted permeability log comprises:
inputting the simulated permeability model into an injection test simulator;
producing predicted injection input parameters from the injection test simulator based on the simulated permeability model;
obtaining observed injection output parameters by performing, using the injection system, an injection test within a test well drilled within the subsurface of interest,
wherein the injection test is based on the predicted injection input parameters;
determining a measured permeability log based on the observed injection output parameters; and
determining the multiplier by calibrating the predicted permeability log for the test well to the measured permeability log.

11. The method of claim 1, wherein the plurality of permeability variogram models comprises a nested permeability variogram model.

12. The method of claim 1, wherein the metric comprises a mean of the plurality of initial pore volumes, and
wherein determining the first intermediate pore volume comprises selecting the initial pore volume among the plurality of initial pore volumes closest to the mean.

13. The method of claim 1, wherein the estimated pore volume comprises a mean of the plurality of second intermediate pore volumes.

14. A system comprising:
a seismic interpretation workstation configured to:
receive, from a seismic acquisition system, a seismic dataset associated with a subsurface of interest, and
for each of a plurality of variants, determine a horizon within the seismic dataset,
wherein the horizon defines a reservoir within the subsurface of interest;
a computer system configured to:
receive, from the seismic interpretation workstation, the horizon,
receive, from a well logging system, a first porosity log and a first permeability log for each of a first plurality of wells drilled within the subsurface of interest,
for each of the plurality of variants:
determine a structural model for the reservoir based on the horizon;
determine an initial porosity model within the structural model based on the first porosity log for the first plurality of wells;
determine a plurality of porosity variogram models based on at least one of the first porosity log for the first plurality of wells and a second porosity log for a second plurality of wells;
for each of the plurality of porosity variogram models, determine a simulated porosity model using each of the plurality of porosity variogram models;
determine an initial permeability model within the structural model based on the first permeability log for the first plurality of wells;
determine a plurality of permeability variogram models based on at least one of the first permeability log for the first plurality of wells and a second permeability log for the second plurality of wells;
for each of the plurality of permeability variogram models, determine a simulated permeability model using each of the plurality of permeability variogram models; and
for each variogram pair among a plurality of variogram pairs, determine an initial pore volume within the structural model based on the simulated porosity model and the simulated permeability model,
wherein each variogram pair comprises one of the plurality of porosity variogram models and one of the plurality of permeability variogram models, and
wherein a plurality of initial pore volumes comprises the initial pore volume for each variogram pair for each of the plurality of variants,
determine a first intermediate pore volume from the plurality of initial pore volumes based on a metric,
generate each of a plurality of second intermediate pore volumes based on the first intermediate pore volume and each of a plurality of seed numbers,
determine an estimated pore volume from the plurality of second intermediate pore volumes, and
configure an injection system to perform a method of injecting the reservoir with an injection fluid based on the estimated pore volume; and
the injection system configured to perform the method of injecting the reservoir.

15. The system of claim 14, further comprising the seismic acquisition system configured to obtain the seismic dataset from the subsurface of interest.

16. The system of claim 14, further comprising the well logging system configured to obtain the first porosity log from each of the first plurality of wells.

17. The system of claim 14, further comprising the well logging system configured to obtain the second porosity log from each of the second plurality of wells.

18. The system of claim 14, further comprising a seismic processing system configured to:
receive, from the seismic acquisition system, the seismic dataset; and
determining a seismic image by processing the seismic dataset.

19. The system of claim 14, further comprising an injection test simulator configured to:
receive, from the computer system, the simulated permeability model; and
produce predicted injection input parameters based on the simulated permeability model.

20. The system of claim 19, wherein the injection system is further configured to:
receive, from the injection test simulator, the predicted injection input parameters; and
obtain observed injection output parameters by performing an injection test within a test well drilled within the subsurface of interest,
wherein the injection test is based on the predicted injection input parameters; and
wherein the computer system is further configured to:
receive, from the injection system, the observed injection output parameters, and
determine the simulated permeability model based on the observed injection output parameters.
